(19) United States
(12) Patent Application Publication
(10) Pub. No.: US 2011/0267190 A1
(43) Pub. Date: Nov. 3, 2011

(54) Anti-Tampering Detection Using Target Circuit RF Signature

(75) Inventors: Ellwood Payson, Fullerton, CA (US); John Leon, Anaheim, CA (US)

(73) Assignee: Irvine Sensors Corporation, Costa Mesa, CA (US)

(21) Appl. No.: 13/098,738

(22) Filed: May 2, 2011

Related U.S. Application Data
(60) Provisional application No. 61/343,709, filed on May 3, 2010.

(51) Int. Cl. G08B 1/08

(52) U.S. Cl. 340/539.31

(57) ABSTRACT

An anti-tampering device and method to inhibit or prevent unauthorized probing of an electronic circuit. Propriety target circuitry transmits a distinct signature in the form of an RF signal which is received by the RF anti-tampering detection circuitry. The transmitted RF signature is monitored by the RF anti-tampering detection circuitry for user-defined changes. In the event an unauthorized attempt is made to probe the target system electronics, the mass of the probe alters the RF transmission characteristics of the RF transmission media, changing the RF signature. The altered RF signature is received by the receiving antenna and RF receiver and is processed by signal processing electronics. The change in the RF signature indicates a tamper event and a predefined anti-tamper event is generated.

### CROSS-REFERENCE TO RELATED APPLICATIONS

This application claims the benefit of U.S. Provisional Patent Application No. 61/343,709, filed on May 3, 2010 entitled “Anti-Tampering Detection Using Target Circuit RF Signature” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of electronic packages and circuits comprising one or more tamper-resistant features.

More specifically, the invention relates to the use of novel RF signature detection circuitry for the monitoring and protection of a proprietary target electronic circuit.

2. Background of the Invention

It is a known concern of military and commercial entities that reverse engineering and evaluation of a proprietary target electronic circuit or package or the contents of an electronic memory contained therein can occur when such a device (e.g., a microelectronic circuit in a military weapons or communications system) falls into an adversary's possession or into the possession of a business competitor. The U.S. government has expressly noted such a concern in a recent directive entitled, “DoD Directive 5200.39, “Research and Technology Protection within the Department of Defense,” issued in March 2002.

Military opponents or commercial competitors can gain an advantage by learning the operation and vulnerability of a proprietary target circuit by electronically probing the circuit to understand its operation. In view of the foregoing concerns, making the reverse engineering by electronic probing of a proprietary circuit difficult or impossible without complex test equipment is needed. Such protection is needed to minimize the possibility an adversary learns key features and functions of a proprietary target circuit and develops means to disable or imitate the circuit.

### BRIEF SUMMARY OF THE INVENTION

The invention is an anti-tampering device and method to inhibit or prevent unauthorized probing of an electronic circuit.

The propriety target circuitry to be protected transmits a distinct and unique RF signature in the form of a radiated RF signal as the result of ordinary operation of the device. The transmitted RF signal is received by the RF anti-tampering detection circuitry of the invention in a normal operating mode (i.e., a non-tamper) calibration cycle, using signal processing means and the expected RF signature characteristics are stored in electronic memory.

After calibration and during normal operation of the proprietary target circuitry, the transmitted RF signature is monitored by the RF anti-tampering detection circuitry for user-defined changes therein such as unexpected noise, amplitude or phase change.

In the event an unauthorized attempt is made to electronically probe the target system electronics, the mass of the probe or the physical change in the RF transmission media in the proximately of the proprietary target circuitry alters the RF transmission characteristics of the RF transmission media surrounding the proprietary target circuitry, changing its transmitted RF signature.

The altered RF signature is received by the receiving antenna and RF receiver and is processed by signal processing electronics.

A user-defined change in the received RF signature is then used to identify and signal a tamper event and a predefined anti-tamper event (i.e., a circuit response) may be generated by suitable circuitry such as the zeroization, erasure or scrambling of the contents of an electronic memory such as firmware or an electronic key, the opening of a over-current device or fusible link or the reconfiguration of one or more internal device switches or I/O in a device such as a field programmable gate array.

In a first aspect of the invention, an electronic device having tamper sensing is provided comprising a proprietary circuit having an operational RF signature, an RF anti-tampering detection circuit comprising RF receiver means for receiving the operational RF signature, and, signal processing means for detecting a predetermined change in the received operational RF signature.

In a second aspect of the invention, the device further comprises means for generating a predetermined anti-tamper event when the predetermined change in the received operational signature is detected.

In a third aspect of the invention, the predetermined anti-tamper event comprises erasing the contents of an electronic memory.

In a fourth aspect of the invention, the predetermined anti-tamper event comprises disabling a circuit element by means of a current sourcing or fuse device.

In a fifth aspect of the invention, the predetermined anti-tamper event comprises the reconfiguration of an I/O in a field programmable gate array.

In a sixth aspect of the invention, the predetermined anti-tamper event comprises the opening of an electronic switch.

In a seventh aspect of the invention, the predetermined response comprises logically reconfiguring a first connection point in the proprietary target circuitry to a second connection point in the proprietary target circuitry.

In an eighth aspect of the invention, the device further comprises an electronic enclosure having a predetermined enclosure RF signal.

In a tenth aspect of the invention, the RF anti-tampering detection circuitry further comprises synchronous demodulator clock means.

In an eleventh aspect of the invention, the RF anti-tampering detection circuitry further comprises RF transmitter means.

In a twelfth aspect of the invention the device further comprises dedicated RF signature transmitting means.

In a thirteenth aspect of the invention, a method for inhibiting or preventing an attempt to analyze a proprietary circuit is disclosed comprising the steps of receiving the RF signature of a proprietary circuit, monitoring the RF signature to detect a predetermined change in the RF signature, and generating a predetermined anti-tamper event when the predetermined change is detected.

These and other aspects of the invention are disclosed in the detailed description that follows below.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 illustrates a block diagram of a preferred embodiment of the RF anti-tampering detection circuit using a target circuit RF signature.

FIG. 2 depicts a block diagram of a preferred embodiment of the anti-tampering detection device using a target circuit RF signature further comprising synchronous demodulator clock means.

FIG. 3 is a block diagram of a preferred embodiment of the anti-tampering detection device using a target circuit RF signature comprising synchronous demodulator clock means and further comprising enclosure signature anti-tamper circuitry.

FIG. 4 shows a block diagram of a preferred embodiment of the anti-tampering detection device using a target circuit RF signature comprising synchronous demodulator clock means and further comprising encrypted transmitter means.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Unauthorized probing attacks and reverse engineering analysis techniques may focus on the sensing of a “target” or “protected” or “proprietary” electronic circuit's output or physical responses as a means of determining the proprietary circuit's characteristics.

For both commercial and military reasons, the operational characteristics of a proprietary circuit preferably remain known only to the manufacturer or authorized user and, as such, need protection from attempts at tampering and reverse engineering.

Unauthorized electronic probing or signal injection analysis of a proprietary target circuit may involve an electronic probe (also referred to as an “attack probe” herein) used in connection with probe test circuitry (e.g., oscilloscope, voltmeter, signal generator, etc.) to detect and evaluate a particular physical or electronic characteristic of the proprietary target electronic circuit so that key operational circuitry characteristics can be determined.

The disclosed device and method address the above and other tampering concerns and are more fully detailed below.

As used herein, the following terms have the following general meanings:

“Target system electronics” generally refers to the overall electronic circuitry of the invention including, for instance, the anti-tamper electronic circuitry, the proprietary target circuitry, the electronic packaging thereof, any sensing, receiving or transmitting circuitry, anti-tamper event circuitry, enclosure or package, memory, firmware and power sources.

“RF anti-tampering detection circuitry” generally refers to the RF electronics used to transmit, monitor, receive, calibrate or perform signal processing functions (sensing) on the RF returned or reflected signature from either the proprietary target circuitry or the optional RF anti-tampering transmitter.

“Proprietary target circuitry” or “circuit” “proprietary circuitry” or “circuit” or “target circuitry” or “circuit” generally refers to the electronics to be protected from probing/intrusion/attack from external sources such as electronic probing or signal injection. Any circuitry which is also part of the RF anti-tampering circuitry may be deemed ‘proprietary’ and, as such, fall under this category to be protected from attempts at unauthorized tampering or probing.

“System electronic package” or “enclosure” generally refers to an electronic package/enclosure in which the target system electronics or target electronics or RF anti-tamper detection circuitry is enclosed.

Various electronic probing attack techniques utilize a sensing device such as an electronic probe in general proximity to the target circuitry, sometimes but not necessarily always in electrical contact with the proprietary target circuit under analysis.

Examples of attack probe techniques using test equipment used to determine proprietary target electronics operational characteristics by non-evasive means include, but are not limited to the following:

1. Probing to measure variations in a proprietary target circuit's electric or magnetic fields,

2. Probing by contact with a proprietary target circuit's electrically conductive traces to measure signal voltage or current changes,

3. Probing to measure a proprietary target circuit's temperature levels or variations in temperature under varying operational functions,

4. Probing a proprietary target circuit by ultra-sonic/vibration measurements.

An attack probe can also determine proprietary target electronics operational characteristics by evasive perturbation techniques including, by way of example and not by limitation, the following:
1. Injecting an electron/particle beam onto or into the proprietary target circuitry and monitoring operational changes,
2. Adding or removing heat to or from portions or areas of the proprietary target circuit and monitoring operational changes,
3. X-ray examination of critical areas of the proprietary target circuit,
4. Directing RF/ultrasonic/visible radiation to critical areas of the proprietary target circuit and monitoring operational changes,
5. Physically vibrating the proprietary target circuitry and monitoring operational changes,
6. Using chemical reactants on the proprietary target circuitry and monitoring operational changes.

Numerous anti-tampering detection techniques have been implemented by target circuit designers, users and manufacturers to sense various types of attack probes and to execute protective mechanisms.

Certain attack probe detection techniques have used mechanically-embedded boundary defense mechanisms (e.g. conducive wrappers that detect when a boundary of a package has been physically compromised). Additionally, some forms of electronic anti-tamper circuitry have been used successfully; typically by sensing a resistive and/or capacitive change in a proprietary target circuit to determine if intrusion has occurred in a critical or predetermined area.

Unfortunately, these prior art techniques have a number of limitations:
1. They either require the boundary mechanism to be broken/breached or are limited by allowing a probe to be within a few millimeter proximity of the boundary wrapper before an anti-tamper attempt can be sensed,
2. They are limited to the area covered by the mechanical boundary device,
3. They have size, fabrication and/or space constraints,
4. They typically have no protection for I/O lines to critical circuits.

Prior art anti-tamper techniques are limited in their ability to detect multiple types of intrusions. The invention herein addresses certain deficiencies in prior art anti-tamper approaches by using the self-radiation RF characteristics of the proprietary target circuitry itself, whereby synchronous demodulation is inherently possible due to the anti-tampering RF receiver's physical proximity to the proprietary target circuitry.

The RF anti-tampering detection receiver and signal processing electronics of the invention may be embedded into the target's system electronics and used to detect variations in signal strength and variations in wave reflections from the self-generated target electronics near-electric and magnetic fields that result from attack probing attempts.

The detection of a variance in the RF signature such as due to a probing attack may, in an alternative embodiment, be used to generate a predetermined anti-tamper event such as, for instance, the zeroization or scrambling of an electronic memory, reconfiguration of one or more device inputs or outputs (such as in an FPGA) or opening of an internal switch or one or more fusible links.

To address the above and other deficiencies in the prior art, the anti-tampering RF signature sensing device and method of the invention may comprise an RF transmitter means, an RF transmission media, an RF receiver means and signal processing means such as signal processing electronics to cooperate with and exploit the inherent and unique RF radiation characteristics of the proprietary target circuitry functioning as a transmitter.

By way of background, digital electronic circuitry generally implements high-speed digital control and timing circuitry which, by its nature, radiates RF signals during operation and which has numerous discrete frequency band characteristics (referred to as RF “signatures” herein). The invention is able to take advantage of these emitted RF signatures and therefore does not require, but may have, its own dedicated RF signature transmitter circuitry.

A novel aspect of the invention in an alternative embodiment is the attenuation of unwanted RF interference by synchronously demodulating the returned RF target-generated signal with the clock signal used by the target circuitry electronics to generate that same signal by using synchronous demodulator clock means.

The RF sensing circuitry of the invention permits significant design flexibility including flexibility in antenna design optimization, the ability to have size/gain tradeoffs, the ability to use RF beam-focusing for the physical area of detection, the ability to configure the device for broadband or to tune for very narrow frequency detection, and the ability to design the antenna for electric or magnetic field detection.

Additionally, the RF receiver can be configured to permit frequency hopping for discrimination of key circuitry signatures, i.e., to determine the physical location of probing based on frequency discrimination.

Any attack probe used in an unauthorized tamper attempt necessarily introduces physical mass in the proximity of the target system electronic circuitry. The mass of the attack probe in the proximity of the target system electronics in turn, alters the physical characteristics of the RF transmission media (e.g., air) in the proximity of the target system electronic circuitry.

By using the RF anti-tampering receiver of the invention, the invention monitors these discrete RF frequencies or signatures for phase, amplitude, frequency shifts, noise, jitter or a combination of any of these. Any detected changes in the received RF signature signal as the result of the attack probe mass altering the RF transmission media are manifested as an altered RF signature having injected jitter or noise, multiple out-of-phase reflections, amplitude changes or a combination thereof.

Turning now to the figures wherein like numerals denote like elements among the several views, a device and method for anti-tampering detection using a target circuit RF signature is disclosed.

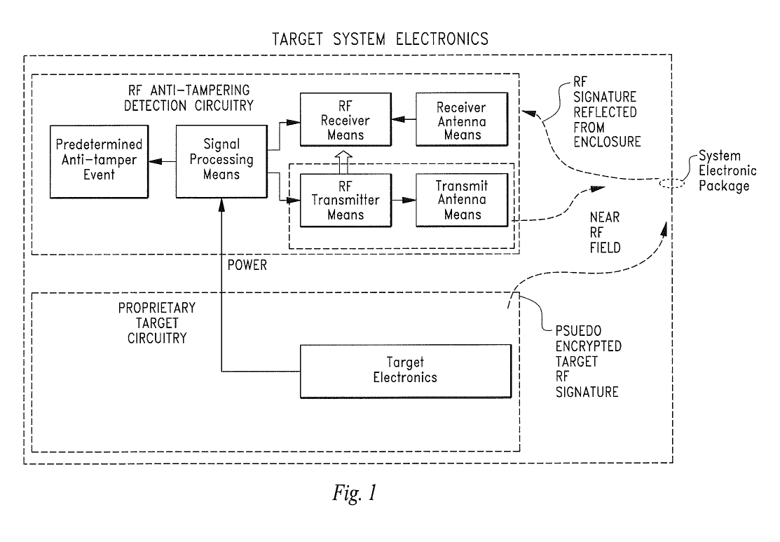

FIG. 1 depicts a simplified block diagram of a preferred embodiment of the target system electronics comprising RF anti-tampering detection circuitry of the invention. By using the RF signals generated by the proprietary target circuitry, no RF signature is propagated outside the target proximity by the RF anti-tampering detection circuitry. Thus, the attack probing circuitry cannot readily determine that RF anti-tampering techniques are being used.

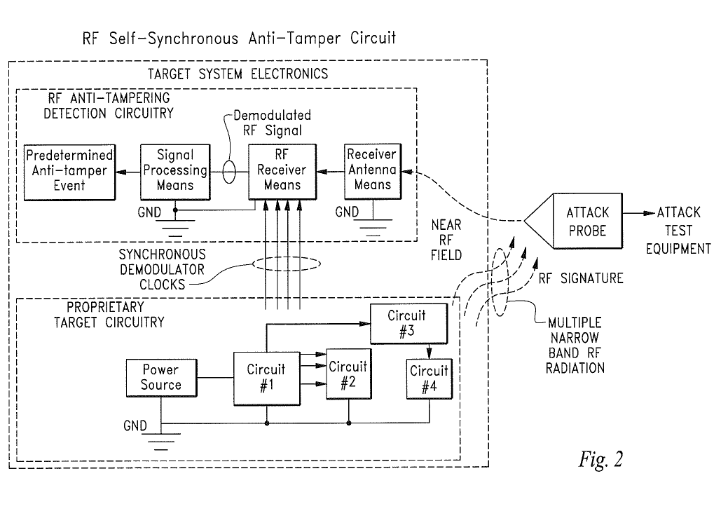

As is seen in the RF self-synchronous anti-tamper circuit of FIG. 2, by demodulating the received target RF signals using synchronous demodulator clocks directly hard-wired from the proprietary target circuitry, synchronous demodulation is achieved. Synchronously demodulating the target RF signature desirably rejects unwanted RF signal noise sources (RF-generated signals external to the target circuitry). The RF receiver circuitry synchronous demodulation embodiment also desirably minimizes false attack triggering alarms.

Further, the ability to synchronously demodulate the varying of the existing target RF signal enables the utilization of the apparent random nature of these target RF signals. This randomness functions as a pseudo encryption/decryption mechanism which is extremely difficult to duplicate by an intruder. The random nature of target RF signals in combination with the RF receiver circuitry and synchronous demodulation means serves to further minimize false attack triggering alarms.

Beneficially, by using the inherent target RF signals generated as part of the target system operation, no additional power from the proprietary target circuitry is required for the RF transmitter signals, thus minimizing anti-tampering circuitry power requirements.

A known aspect of near-electromagnetic field characteristics is that both the electric and magnetic field varies (not the inverse square as are far-electromagnetic fields) to the inverse of the 4^{th} power as an intrusive object (e.g., an attack probe) approaches the proprietary target circuitry. Accordingly, as an attack probe approaches the proprietary target circuitry, the near-field pattern (either electric or magnetic) field and signal will change quickly and as the distance to the 4^{th} power as the probe approaches the target. This known characteristic permits the anti-tampering RF detection receiver to more easily perform a derivative function on the received signal that is the result of the physical intrusion of the transmission media. Thus, the DC component of the received intrusion is eliminated as is the need for an offset signal calibration. This significantly simplifies electronic detection.

Detecting RF returned phase variations over relatively small distances requires relatively fast detection circuitry (e.g., 3 GHz for a 4-inch phase shift). Though phase monitoring is desirable, it is not a requirement for the device or method of the invention. As enclosure sizes increase and electronic circuitry speed increases, phase detection becomes a more readily available alternative measurement technique.

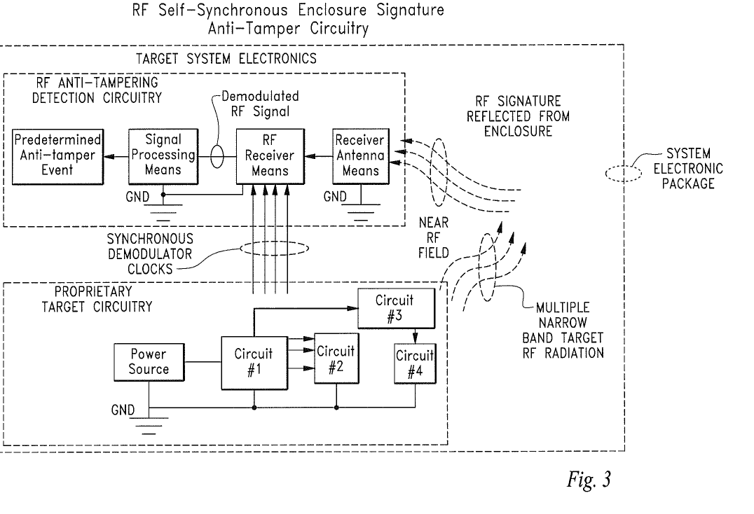

In the RF self-synchronous enclosure signature anti-tamper circuitry embodiment of FIG. 3, the proprietary target circuitry may be enclosed in a system electronic enclosure or package having a unique, predetermined enclosure RF signature. The enclosure RF signature is monitored and when a change in the enclosure RF signature is detected such as due to a breach or alteration of the enclosure, a tamper event is detected by the monitoring circuitry, in turn generating a predetermined anti-tamper event.

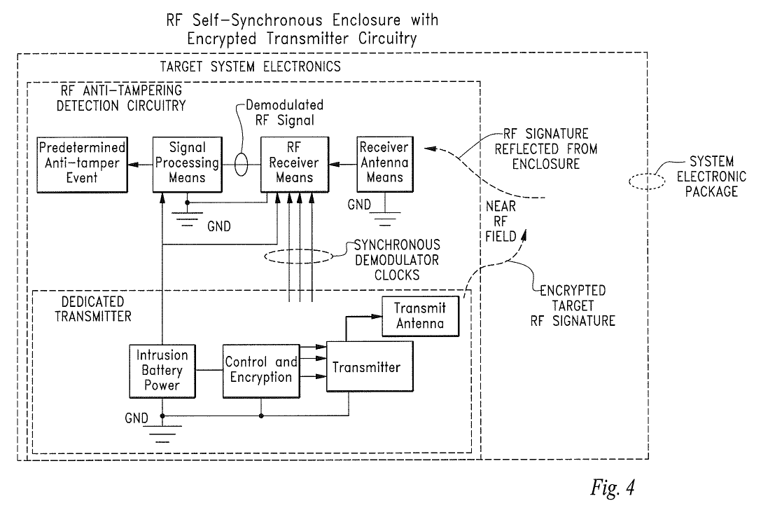

In the alternative preferred embodiment of the RF self-synchronous enclosure with encrypted transmitter circuitry of FIG. 4, dedicated anti-tampering transmitter means is provided to allow independent operation separate and apart from the operation of the proprietary target circuitry.

Temporal encryption of the anti-tampering transmission allows added false triggering minimization and a low duty cycle allows for long-term, low power stand-by anti-tampering operation. In this embodiment, the proprietary target circuitry need not be powered on or operation to permit active anti-tampering monitoring.

The preferred embodiment of the RF anti-tampering detection circuitry of the invention illustrated in FIG. 4 comprises a receiver antenna means, RF receiver means, and electronic signal processing means. The antenna means may be either part of the proprietary target circuitry or a separate, discrete stand-alone antenna.

In this preferred embodiment, trace signals may be part of the system printed circuit board and are received by the anti-tampering circuitry from the proprietary target circuitry to synchronously demodulate the received target RF transmitted signals. These signals may be continuous or pseudo-random in nature. When the target circuitry is operating in a safe/secure (e.g., by an authorized user) state, the anti-tampering circuitry may perform a one-time calibration cycle, which writes an RF signature return pattern into the signal processing memory.

In this manner, any variation in the RF target return signature pattern is detected by the anti-tampering signal processing circuit (cross-correlated to the one-time RF calibrated signature) and appropriate anti-tampering measures such as the generation of an anti-tamper event are taken.

The embodiment of FIG. 4 is similar to that shown in FIG. 3 wherein the RF anti-tampering detection circuitry is enclosed in an electronic package or enclosure, but which enclosure may be fabricated or provided so as to have a predefined RF return signature signal. In like manner to the embodiment of FIG. 3, any variation in the proprietary RF target return signature pattern in the embodiment of FIG. 4 is detected by the anti-tampering signal processing circuit (cross-correlated to RF calibrated signature) and appropriate anti-tampering measures may be taken.

The embodiment of FIG. 4 may be provided with a dedicated RF transmitter that is included with the anti-tampering RF circuitry. This circuitry may also be configured to synchronously demodulate the package returned signal generated from the optional RF anti-tampering transmitter.

By encrypting the optional RF anti-tampering transmitted RF signal and implementing a very low transmit power duty cycle; the power can be reduced to allow operation for extended periods using a small battery (e.g. a coin-cell type battery). This permits package intrusion detection, while the proprietary target circuitry is in storage or in stand-by operation.

The proprietary target circuitry may be enclosed in a sealed package or enclosure, which may be fabricated to have its own distinct RF return signature signal. In this embodiment, the anti-tampering transmitter initiates a one-time calibration as a means of determining the initial package RF signature. Any variation in the RF return signature pattern is detected by the anti-tampering signal processing circuitry (cross-correlated to RF calibrated signature) and appropriate anti-tampering measures taken.

Since various parts of the target proprietary circuitry emit their own frequency signature, by implementing multiple RF receivers, frequency hopping, or frequency band-sweeping, the RF anti-tampering circuitry can be used to determine the physical location of these attacks. This embodiment may use frequency hopping for discrimination of key circuitry signatures (to determine the physical location of probing based on frequency discrimination). By determining the physical point of attack, the target circuitry electronics can perform anti-tampering measures (such as memory erasure) based on physical attack location prioritization. Desirably, this embodiment allows for both temporal and spatial anti-tampering countermeasures due to the ability to convert frequency attack signatures to the location of attack. For example, knowing the location of the attack allows the anti-tamper electronics to selectively zero or set a time priority on memory areas to be zeroed.

Since electric and magnetic near-field performance vary significantly, the anti-tampering circuitry of the invention may be designed to use either a closed-loop antenna or a dipole antenna, and thus be geared toward a specific anti-tampering application. This gives added flexibility in the design phase geared toward individual applications.

The invention permits the implementation of a number of antenna designs. The antenna may be any or combination of the following (includes but not limited to the following): near-electric field type antenna, near-magnetic field type antenna, wrapper/chassis antenna, circuit board outer planes, PCB antennas or a combination of any of the above.

The anti-tampering RF technique of the invention enables the RF field signature characterization of the entire target electronic package after the target circuitry electronics has been encapsulated or enclosed.

Once enclosed in its package, the target circuitry electronics may determine this RF field signature as part of a one-time calibration process. This one-time signature calibration may be used as a baseline for package intrusion monitoring. RF reflective material can be used as an element of the target electronic package to enable adequate RF target signal return sensitivity.

Typically, both phase and amplitude RF return signal characteristics may each be used as the baseline calibration parameter, which results can be used in FFT characterization and implementation of temporal cross-correlation techniques to the RF signature signal (signal processing) as a means of determining out-of-bound RF field signatures as representative of an attack.

Phase detection requires both high sensitivity and high frequency circuitry. Though practical and desirable, phase detection is not a prerequisite for implementing or practicing the invention.

The RF anti-tampering receiver synchronous demodulation means enables temporal pulse encryption/description of the reflected target RF signal. In many cases, encryption can be implemented as a normal part of an anti-tampering target electronics architecture. Since the RF receiver has access to the encryption key, decryption of the receiver RF target circuitry signal can be used to discriminate against the possibility of unwanted false triggering.

In a further alternative embodiment, a low-power anti-tampering encrypted transmitter may be added to a packaged RF anti-tamper detection sensing system of the invention to permit a high level of application flexibility for stand-by anti-tampering detection. The RF transmitter may be pulsed periodically (temporal encrypted) at a relatively low power duty cycle (60 usec every 6 sec; 1:100,000 power ratio). After an initial calibration operation (e.g., inside the target enclosure), the RF anti-tampering receiver will synchronously demodulate the returned RF target signal package signature (decrypted) and analyzed signal for intrusion.

For example, if it is assumed that the RF anti-tampering transmitter/receiver and signal processing means interrogates 600 usec every 6 sec., the total time the transmitter/receiver would be on per month is:

$$\begin{matrix}= 434000 ( 6 sec\_cycle \text{/} month ) * 600 e - 6 ( sec\_on \text{/} 6 sec\_cycle ) \\ = 259 sec \text{/} month .\end{matrix}$$

If the anti-tampering receiver/transmitter each generates 5 mW (10 mW total) and any signal processing draws about 10 mW, the total is about 20 mW. The combination draws <6 ma peak current from a 3V battery.

Now, 6 ma for 300 sec/month→<1 mAH/month. Based on the foregoing, the device in this embodiment can be expected to operate for about one year using a small coin cell battery having about a 12 mAH rating.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. An electronic device comprising:
a proprietary circuit having an operational RF signature,
an RF anti-tampering detection circuit comprising RF receiver means for receiving the operational RF signature, and,
signal processing means for detecting a predetermined change in the received operational RF signature.
The device of claim 1 further comprising means for generating a predetermined anti-tamper event when the predetermined change in the received operational signature is detected.
The device of claim 2 wherein the predetermined anti-tamper event comprises erasing the contents of an electronic memory.
The device of claim 2 wherein the predetermined anti-tamper event comprises disabling a circuit element by means of an over-current protection device.
The device of claim 2 wherein the predetermined anti-tamper event comprises the reconfiguration of an I/O in a field programmable gate array.
The device of claim 2 wherein the predetermined anti-tamper event comprises the opening of an electronic switch.
The device of claim 2 wherein the predetermined response comprises logically reconfiguring a first connection point in the proprietary target circuitry to a second connection point in the proprietary target circuitry.
The device of claim 2 further comprising an electronic enclosure having a predetermined enclosure RF signal.
The device of claim 2 wherein the RF anti-tampering detection circuitry further comprises synchronous demodulator clock means.
The device of claim 2 wherein the RF anti-tampering detection circuitry further comprises RF transmitter means.
The device of claim 2 further comprising dedicated RF signature transmitting means.
A method for inhibiting or preventing an attempt to analyze a proprietary circuit comprising the steps of:
receiving the RF signature of a proprietary circuit,
monitoring the RF signature to detect a predetermined change in the RF signature,
generating a predetermined anti-tamper event when the predetermined change is detected.
